(19) United States
(12) Patent Application Publication
(10) Pub. No.: US 2022/0049144 A1
(43) Pub. Date: Feb. 17, 2022

(54) Clay Stabilization Composition

(71) Applicant: NACHURS ALPINE SOLUTIONS, Marion, OH (US)

(72) Inventor: Franklin O. Kroh, Marion, OH (US)

(21) Appl. No.: 17/276,569

(22) PCT Filed: Sep. 17, 2019
(86) PCT No.: PCT/US19/51533

§ 371 Date: Mar. 16, 2021

Related U.S. Application Data
(60) Provisional application No. 62/732,814, filed on Sep. 18, 2018.

(51) Int. Cl. C09K 8/035

(52) U.S. Cl. CPC C09K 8/035; C09K 2208/12

(57) ABSTRACT

A clay swelling inhibitor additive for oil and gas well treatment is disclosed. The additive comprises an aqueous solution of a water-soluble polymer and ammonium acetate. The additive composition synergistically retards water absorption by the down-hole clay formation.

### CROSS-REFERENCE TO PRIOR APPLICATIONS

The present application claims priority to U.S. Patent Application 62/732,814 filed 18 Sep. 2018, which is incorporated herein by reference in its entirety.

### FIELD OF THE INVENTION

The present invention relates to a clay swelling inhibitor composition suitable for use in oil and gas well treatment.

### BACKGROUND OF THE INVENTION

Hydraulic fracturing has been utilized for many years to stimulate the production of oil, gas or other formation fluids from subterranean formations. In hydraulic fracturing, a suitable fluid is introduced into the down-hole formation by way of a well bore under conditions of flow rate and pressure which are at least sufficient to create or extend a fracture into a desired portion of the formation. Various fluids have been utilized in hydraulic fracturing, however, most fluids utilized today are aqueous-based liquids.

The presence of clay in an oil and gas producing formation poses a problem for production from wells completed in such formations. Ordinarily, such clays are inert in the formation and do not disrupt the flow of hydrocarbons. When disturbed, however, by aqueous-based fluids used in well stimulation, for example, clay particles can swell and reduce formation permeability.

In order to inhibit the swelling phenomenon, minimization of the hydratable surface area of the clay is necessary. One way that this may be accomplished is by flocculating and decreasing the surface charge density, or by increasing the ionic strength of the aqueous phase, or both. By allowing cations to associate with the particle, the effective strength of the negatively charged, double-face platelet layer surfaces will be diminished, allowing greater platelet-platelet interaction. Increasing the ionic strength of the solution will also have the same effect. Ammonium ions (NH₄) have been shown to be effective for creating electrostatic links and reducing osmotic migration of water, resulting in improved flocculation of clays.

### SUMMARY OF THE PRESENT INVENTION

The present development is a clay swelling inhibitor additive composition for oil and gas well treatment. The additive comprises an aqueous solution of a water-soluble polymer and ammonium acetate. In a preferred embodiment, the additive comprises an aqueous solution of poly(diallyl dimethylammonium chloride) or poly-DADMAC and ammonium acetate. The additive composition synergistically retards water absorption by the down-hole clay formation and is effective to inhibit clay swelling in a down-hole formation. The degree of inhibition of clay swelling achieved by the combination of the poly-DADMAC and the ammonium acetate is, quite surprisingly, greater than an additive effect of each component alone, and appears to be synergistic. In a preferred embodiment, the water-soluble polymer comprises from about 3 to about 15 percent by weight of the aqueous solution, especially from about 5 to about 10 percent by weight, and the ammonium acetate comprises from about 30 to about 70 percent by weight, especially from about 45 to about 55 percent by weight.

### DETAILED DESCRIPTION OF THE PRESENT DEVELOPMENT

The following description is intended to provide the reader with a better understanding of the invention. The description is not intended to be limiting with respect to any element not otherwise limited within the claims.

The stabilizing additive composition of the present invention consists essentially of (a) ammonium acetate, (b) a water-soluble polymer, and (c) water. In a preferred embodiment, the stabilizing additive composition of the present invention consists essentially of (a) ammonium acetate, (b) poly(diallyl dimethylammonium chloride) or poly-DADMAC, and (c) water. By “consists essentially of” it is meant that no other active components are present in the composition, but non-active components may be added to a concentration of up to 1 percent by weight. By “non-active components” it is meant that the component does not interact with the ammonium acetate or with the poly-DADMAC or with the water to produce a different chemical compound, and the non-active component does not interact with the clay so as to stabilize the clay. Representative non-active components include colorants, dyes, fragrances, bactericides, breakers, iron control agents, foaming agents such as surfactants and combinations thereof.

The first component of the stabilizing additive of the present invention is an aqueous ammonium acetate solution. The ammonium acetate comprises from about 30 percent to about 70 percent by weight of the aqueous composition, preferably from about 45 percent to about 55 percent by weight of the aqueous composition, and more preferably from about 47 percent to about 50 percent by weight of the aqueous composition.

The second component of the stabilizing additive comprises a water-soluble polymer, and preferably a polyquaternium. In a preferred embodiment, the polymer is poly (diallyl dimethyl ammonium chloride) or poly-DADMAC, a homopolymer of diallyldimethylammonium chloride (DADMAC), which is a water-soluble quaternary amine-based cationic polyelectrolyte. By “water soluble” it is meant that the polyelectrolytes are soluble or dispersible in the ammonium acetate solution at an effective concentration. The poly-DADMAC preferably has a molecular weight sufficiently high so that it has low volatility, but on the other hand, the molecular weight should not be so high that the poly-DADMAC is water insoluble. Poly-DADMAC is commercially available and is normally marketed with molecular weight ranges of very low (<100,000 daltons), low (100,000-200,000 daltons), medium (200,000-350,000 daltons), high (400,000-500,000 daltons) and very high (>500,000 daltons). For the present clay stabilization composition, any poly-DADMAC may be used. In a preferred embodiment, the poly-DADMAC has a very low, low, medium or high molecular weight. In a more preferred embodiment, the poly-DADMAC has a low or medium molecular weight. In a most preferred embodiment, the poly-DADMAC has a medium molecular weight. The poly-DADMAC comprises from about 3 percent to about 10 percent by weight of the aqueous composition, preferably from about 5 percent to about 10 percent by weight of the aqueous composition, and most preferably about 7 percent by weight.

To prepare the clay stabilizing fluid additive, ammonium acetate powder is dissolved in water to obtain an ammonium acetate solution of a predetermined concentration or ammonium acetate is generated by reacting aqueous ammonia with acetic acid. Poly-DADMAC is added to the ammonium acetate solution and the mixture is gently agitated to homogenize.

Example—Preparation of Sample 1: Sufficient ammonium acetate powder is dissolved in water to obtain a 60% ammonium acetate solution. 80 grams of the 60% ammonium acetate solution is transferred to a reaction vessel. 20 grams of a very low molecular weight poly(diallyldimethylammonium chloride) solution (35% wt in water; available from Sigma-Aldrich) is added to the ammonium acetate solution and the mixture is gently agitated to homogenize. The resulting composition is about 48 wt % ammonium acetate and about 7 wt % poly-DADMAC. The sample is labelled Sample 1.

Example—Preparation of Sample 2: The method of Sample 1 is followed except 20 grams of Kemira Superfloc C-592 is used in place of the very low molecular weight poly-DADMAC. The resulting composition is about 48 wt % ammonium acetate and about 7 wt % poly-DADMAC. The sample is labelled Sample 2.

The capillary suction time (CST) test is a commonly used method to measure the filterability and the ease of removing moisture from slurry and sludge in numerous environmental and industrial applications. Using CST, Sample 1 was evaluated at three different concentrations along with commercially available potassium chloride (prepared as a 2% by weight solution) and a 70% choline chloride solution. Based on results from the CST, the clay stabilizing composition of the present invention demonstrates significantly better clay stabilization than prior art compositions, as shown in Table I.

TABLE I

| | | | Blank | |
|---|---|---|---|---|
| Fluid | CST Avg | Std Dev | Avg Used | CST Ratio² |
| Fresh Water Baseline | 101.267 | 1.10 | 6.73 | 14.04 |
| 2% KCl | 15.025 | 0.99 | 6.73 | 1.23 |
| 2 gpt 70% choline chloride | 12.877 | 0.40 | 6.73 | 0.91 |
| 0.5 gpt¹ Sample 1 | 18.933 | 0.85 | 6.73 | 1.81 |
| 1.0 gpt Sample 1 | 13.825 | 0.38 | 6.73 | 1.05 |
| 2.0 gpt Sample 1 | 11.375 | 0.39 | 6.73 | 0.69 |

¹gpt = gallons per thousand
²CST Ratio = (Time Sample-Time Blank)/Time Blank

Unless defined otherwise, all technical and scientific terms used herein have the same meaning as commonly understood by one of ordinary skill in the art to which the presently disclosed subject matter pertains. Representative methods, devices, and materials are described herein, but are not intended to be limiting unless so noted.

The terms “a”, “an”, and “the” refer to “one or more” when used in the subject specification, including the claims. Unless otherwise indicated, all numbers expressing quantities of components, conditions, and otherwise used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter. As used herein, the term “about”, when referring to a value or to an amount of mass, weight, time, volume, concentration, or percentage can encompass variations of, in some embodiments±20%, in some embodiments±10%, in some embodiments±5%, in some embodiments±1%, in some embodiments±0.5%, and in some embodiments to ±0.1%, from the specified amount, as such variations are appropriate in the disclosed application.

All compositional percentages used herein are presented on a “by weight” basis, unless designated otherwise.

What is claimed is:

1. A composition for clay stabilization consisting essentially of ammonium acetate, poly(diallyl dimethylammonium chloride) and water.

2. The composition of claim 1 wherein the ammonium acetate is in solution form prepared by dissolving an ammonium acetate powder in water or by reacting aqueous ammonia with acetic acid.

3. The composition of claim 1 wherein the ammonium acetate comprises from about 30 percent to about 70 percent by weight of the aqueous composition.

4. The composition of claim 1 wherein the ammonium acetate comprises from about 45 percent to about 55 percent by weight of the aqueous composition.

5. The composition of claim 1 wherein the ammonium acetate comprises from about 47 percent to about 50 percent by weight of the aqueous composition.

6. The composition of claim 1 wherein the poly(diallyl dimethylammonium chloride) or poly-DADMAC has a very low, low, medium or high molecular weight.

7. The composition of claim 6 wherein the poly(diallyl dimethylammonium chloride) has a medium molecular weight.

8. The composition of claim 6 wherein the poly-DADMAC has a molecular weight of <500,000 daltons.

9. The composition of claim 8 wherein the poly-DADMAC has a molecular weight of <100,000 daltons or the poly-DADMAC has a molecular weight of 100,000-200,000 daltons or the poly-DADMAC has a molecular weight of 200,000-350,000 daltons or the poly-DADMAC has a molecular weight of 400,000-500,000 daltons.

10. The composition of claim 9 wherein the poly-DADMAC has a molecular weight of 100,000-350,000 daltons.

11. The composition of claim 10 wherein the poly-DADMAC has a molecular weight of 200,000-350,000 daltons.

12. The composition of claim 1 wherein the poly-DADMAC comprises from about 3 percent to about 10 percent by weight of the aqueous composition.

13. The composition of claim 12 wherein the poly-DADMAC comprises from about 5 percent to about 10 percent by weight of the aqueous composition.

14. The composition of claim 13 wherein the poly-DADMAC comprises about 7 percent by weight.

15. The composition of claim 1 further comprising at least one non-active component wherein the non-active component does not interact with the ammonium acetate or with the poly-DADMAC or with the water to produce a different chemical compound and wherein the non-active component does not interact with the clay so as to stabilize the clay.

16. The composition of claim 15 wherein the at least one non-active component is selected from colorants, dyes, fragrances, bactericides, breakers, iron control agents, foaming agents, surfactants, and combinations thereof.
